(19) United States
(12) Patent Application Publication
(10) Pub. No.: US 2015/0034222 A1
(43) Pub. Date: Feb. 5, 2015

(54) TIRE AND SYSTEM FOR ACQUIRING DATA ASSOCIATED WITH TIRE

(71) Applicant: CATERPILLAR INC., Peoria, IL (US)

(72) Inventors: KEVIN L. MARTIN, Washburn, IL (US); Matthew J. Behmlander, Metamora, IL (US); Jeremy R. Hammar, Germantown Hills, IL (US); David J. Colantoni, Metamora, IL (US); Stephen J. Pierz, Peoria, IL (US); Trent J. Cleveland, Metamora, IL (US)

(73) Assignee: CATERPILLAR INC., Peoria, IL (US)

(21) Appl. No.: 13/954,462

(22) Filed: Jul. 30, 2013

(51) Int. Cl. G01M 17/02; G01K 13/00; B60C 7/00; B60C 23/20; B60C 19/00

(52) U.S. Cl. CPC G01M 17/02; B60C 23/20; B60C 19/00; B60C 7/00; G01K 13/00; B60C 2019/004; B60C 2007/005
USPC 152/154.2; 152/323; 73/146; 374/141

(57) ABSTRACT

A non-pneumatic tire may include a support structure having an inner circumferential portion configured to be associated with a hub. The tire may further include a tread portion associated with an outer circumferential portion of the support structure. The tire may also include at least one sensor associated with at least one of the support structure and the tread portion and configured to generate signals indicative of at least one characteristic associated with at least one of the support structure and the tread portion. The tire may further include a receiver associated with at least one of the support structure and the tread portion and configured to receive signals from the at least one sensor. The tire may also include a transmitter associated with at least one of the support structure and the tread portion and configured to transmit the signals to a location remote from the tire.

### TECHNICAL FIELD

The present disclosure relates to tires and systems for acquiring data associated with tires, and more particularly, to non-pneumatic tires and systems for acquiring data associated with non-pneumatic tires.

### BACKGROUND

It may be desirable to acquire data associated with tires installed on vehicles, so that such data may be used for various purposes. For example, it may be desirable to be able to effectively monitor the tread wear of a tire so that the tire may be replaced prior to becoming unusable. In addition, it may be desirable to effectively monitor other characteristics associated with the tire such as temperature, load, or rotational speed, for example, in order to increase the likelihood that the tire will not be operated beyond its designed performance envelope. In addition, it may be desirable to effectively monitor characteristics associated with operation of a tire in order develop technology associated with the tire, for example, to improve its performance or durability.

Some tires may be molded from a moldable material such as polyurethane. For example, molded, non-pneumatic tires may be formed from polyurethane or similar materials. Such tires may be used by vehicles, and thus, it may be desirable to monitor the wear of the tread portion of such tires so that either the entire tire or the tread portion can be replaced. In addition, due to the nature of polyurethane and similar materials, it may be desirable to monitor characteristics such as temperature, load, and/or moisture levels associated with portions of the tire in order to reduce the likelihood of exceeding the capabilities of the material.

An example of a method of detecting the state of a vehicle tire and roadway is disclosed in U.S. Pat. No. 8,332,092 B2 to Laermer et al. (“the '092 patent”). In particular, the method and device of the '092 patent includes at least one acceleration sensor disposed in the tire interior that generates a signal that is assigned to physical variables of the vehicle tire and/or the roadway. According to the '092 patent, the state of the tire and/or characteristics of the roadway may be determined on the basis of the generated signal.

Although the method disclosed in the '092 patent purports to determine tire information and road characteristics with high reliability, the '092 patent does not disclose a tire, system, or method that provides characteristics associated with a non-pneumatic tire. In addition, the method of the '092 patent may be overly complex and impractical for use with mass-produced non-pneumatic tires.

The tire and associated systems and methods disclosed herein may be directed to mitigating or overcoming one or more of the possible drawbacks set forth above.

### SUMMARY

According to a first aspect, the present disclosure is directed to a non-pneumatic tire. The non-pneumatic tire may include a support structure having an inner circumferential portion and an outer circumferential portion, the inner circumferential portion being configured to be associated with a hub. The tire may further include a tread portion associated with the outer circumferential portion of the support structure. The tire may also include at least one sensor associated with at least one of the support structure and the tread portion and configured to generate signals indicative of at least one characteristic associated with at least one of the support structure and the tread portion of the tire. The tire may further include a receiver associated with at least one of the support structure and the tread portion and configured to receive signals from the at least one sensor. The tire may also include a transmitter associated with at least one of the support structure and the tread portion and configured to transmit signals indicative of the at least one characteristic to a location remote from the tire.

According to a further aspect, a system for acquiring data associated with a non-pneumatic tire may include at least one sensor configured to be received in a portion of the tire and to generate signals indicative of at least one characteristic associated with the tire. The system may further include a receiver configured to be received in a portion of the tire and to receive signals from the at least one sensor. The system may also include a transmitter configured to be received in a portion of the tire and to transmit signals indicative of the at least one characteristic to a location remote from the tire.

According to a further aspect, a method for acquiring data associated with a non-pneumatic tire may include generating signals via at least one sensor received in a portion of the tire, the signals being indicative of at least one characteristic associated with the tire. The method may further include receiving via a receiver received in a portion of the tire, the signals associated with the at least one characteristic. The method may also include transmitting via a transmitter received in a portion of the tire, the signals associated with the at least one characteristic to a location remote from the tire.

### BRIEF DESCRIPTION OF THE DRAWINGS

FIG. 1 is a side view of an exemplary embodiment of a machine including an exemplary embodiment of a non-pneumatic tire.

FIG. 2 is a perspective view of an exemplary embodiment of a non-pneumatic tire.

FIG. 3 is a partial section view of an exemplary embodiment of a non-pneumatic tire.

FIG. 4 is a perspective view of an exemplary embodiment of a non-pneumatic tire including an exemplary embodiment of a system for acquiring data associated with the exemplary non-pneumatic tire.

FIG. 5 is detail view of a portion of FIG. 4 showing portions of an exemplary system for acquiring data associated with the non-pneumatic tire.

FIG. 6 is a perspective view of a portion of an exemplary embodiment of a system for acquiring data associated with a non-pneumatic tire.

FIG. 7 is a block diagram of an exemplary embodiment of a system for acquiring data associated with a non-pneumatic tire.

### DETAILED DESCRIPTION

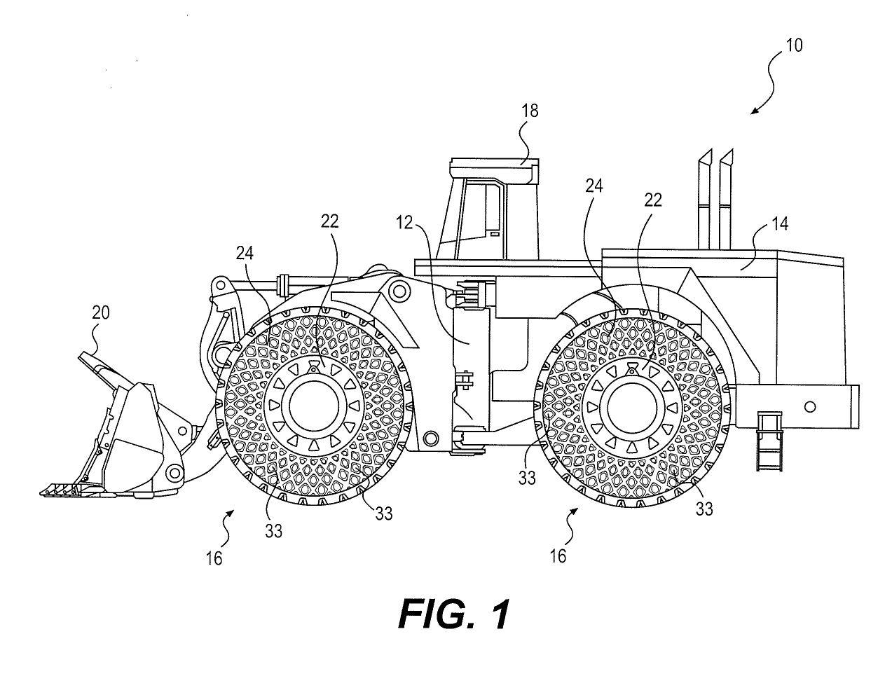

FIG. 1 shows an exemplary machine 10 configured to travel across terrain. Exemplary machine 10 shown in FIG. 1 is a wheel loader. However, machine 10 may be any type of ground-borne vehicle, such as, for example, an automobile, a truck, an agricultural vehicle, and/or a construction vehicle, such as, for example, a dozer, a skid-steer loader, an excavator, a grader, an on-highway truck, an off-highway truck, and/or any other vehicle type known to a person skilled in the art. In addition to self-propelled machines, machine 10 may be any device configured to travel across terrain via assistance or propulsion from another machine.

Exemplary machine 10 shown in FIG. 1 includes a chassis 12 and a powertrain 14 coupled to and configured to supply power to wheels 16, so that machine 10 is able to travel across terrain. Machine 10 also includes an operator station 18 to provide an operator interface and protection for an operator of machine 10. Machine 10 also includes a bucket 20 configured to facilitate movement of material. As shown in FIG. 1, exemplary wheels 16 include a hub 22 coupled to powertrain 14, and tires 24 coupled to hubs 22. Exemplary tires 24 are molded tires, such as, for example, molded, non-pneumatic tires.

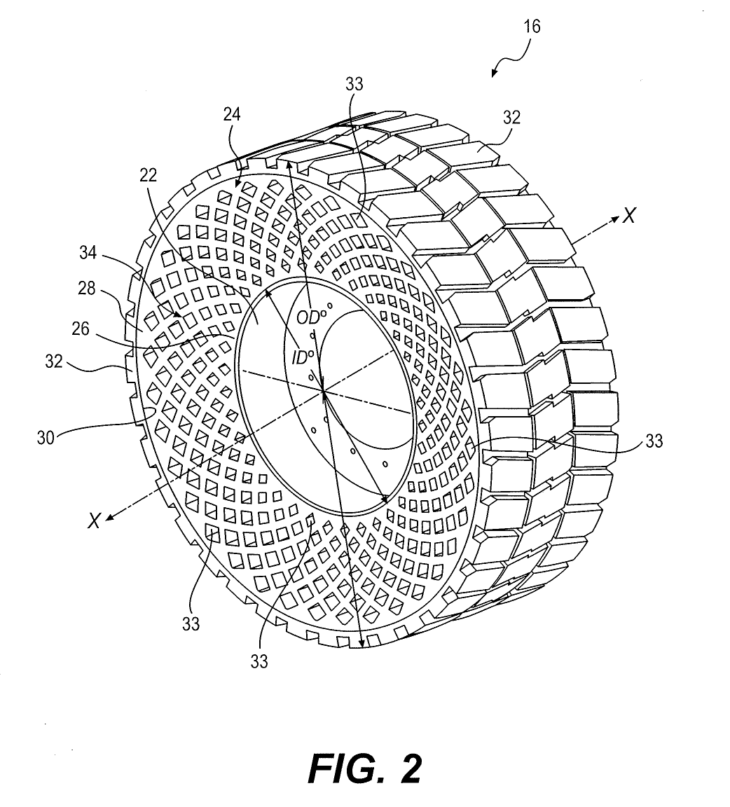

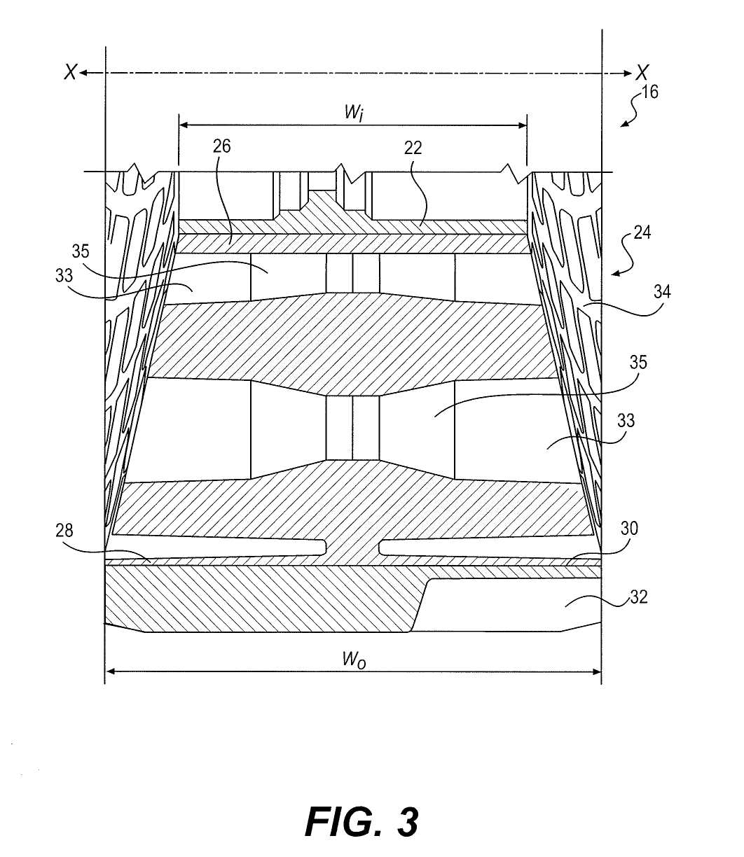

The exemplary tire 24 shown in FIGS. 2 and 3 includes an inner circumferential portion 26 configured to be coupled to a hub 22, and an outer circumferential portion 28 configured to be coupled to an inner surface 30 of a tread portion 32 configured to improve traction of tire 24 at the interface between tire 24 and the terrain across which tire 24 rolls. Extending between inner circumferential portion 26 and outer circumferential portion 28 is a support structure 34. Exemplary support structure 34 serves to couple inner circumferential portion 26 and outer circumferential portion 28 to one another. As shown in FIGS. 1-3, exemplary tire 24 includes a plurality of cavities 33 configured to provide support structure 34 with a desired level of support and cushioning for tire 24. According to some embodiments, one or more of cavities 33 may have an axial intermediate region 35 having a relatively smaller cross-section than the portion of cavities 33 closer to the axial sides of tire 24.

According to some embodiments, one or more of inner circumferential portion 26 and outer circumferential portion 28 are part of support structure 34. Hub 22 and/or inner circumferential portion 26 may be configured to facilitate coupling of hub 22 to inner circumferential portion 26. According to some embodiments, support structure 34, inner circumferential portion 26, outer circumferential portion 28, and/or tread portion 32 are integrally formed as a single, monolithic piece, for example, via molding. Tread portion 32 and support structure 34 may be chemically bonded to one another. For example, the material of tread portion 32 and the material of support structure 34 may be covalently bonded to one another. According to some embodiments, support structure 34, inner circumferential portion 26, and/or outer circumferential portion 28 are integrally formed as a single, monolithic piece, for example, via molding, and tread portion 32 is formed separately in time and/or location and is joined to support structure 34 in a common mold assembly to form a single, monolithic piece. Even in such embodiments, tread portion 32 and support structure 34 may be chemically bonded to one another. For example, the material of tread portion 32 and the material of support structure 34 may be covalently bonded to one another.

Exemplary tire 24, including inner circumferential portion 26, outer circumferential portion 28, tread portion 32, and support structure 34, may be configured to provide a desired amount of traction and cushioning between a machine and the terrain. For example, support structure 34 may be configured to support the machine in a loaded, partially loaded, and empty condition, such that a desired amount of traction and/or cushioning is provided, regardless of the load.

For example, if the machine is a wheel loader as shown in FIG. 1, when its bucket is empty, the load on one or more of wheels 16 may range from about 60,000 lbs. to about 160,000 lbs. (e.g., 120,000 lbs.). In contrast, with the bucket loaded with material, the load on one or more of wheels 16 may range from about 200,000 lbs. to about 400,000 lbs. (e.g., 350,000 lbs.). Tire 24 may be configured to provide a desired level of traction and cushioning, regardless of whether the bucket is loaded, partially loaded, or empty. For smaller machines, correspondingly lower loads are contemplated. For example, for a skid-steer loader, the load on one or more of wheels 16 may range from about 1,000 lbs. empty to about 3,000 lbs. (e.g., 2,400 lbs.) loaded.

Tire 24 may have dimensions tailored to the desired performance characteristics based on the expected use of the tire. For example, exemplary tire 24 may have a rotational axis X, an inner diameter ID for coupling with hub 22 ranging from 0.5 meters to 4 meters (e.g., 2 meters), and an outer diameter OD ranging from 0.75 meters to 6 meters (e.g., 4 meters) (see FIG. 2). According to some embodiments, the ratio of the inner diameter of tire 24 to the outer diameter of tire 24 ranges from 0.25:1 to 0.75:1, or 0.4:1 to 0.6:1, for example, about 0.5:1. Support structure 34 may have an inner axial width Wᵢ at inner circumferential portion 26 (see FIG. 3) ranging from 0.05 meters to 3 meters (e.g., 0.8 meters), and an outer axial width Wₒ at outer circumferential portion 28 ranging from 0.1 meter to 4 meters (e.g., 1 meter). For example, exemplary tire 24 may have a trapezoidal cross-section (see FIG. 3). Other dimensions are contemplated. For example, for smaller machines, correspondingly smaller dimensions are contemplated.

According to some embodiments, tread portion 32 and support structure 34 are formed either separately or together from the same type of polyurethane (i.e., a polyurethane having the same material characteristics). According to some embodiments, tread portion 32 is formed from a first polyurethane having first material characteristics, and support structure 34 is formed from a second polyurethane having second material characteristics different than the first material characteristics. According to some embodiments, tread portion 32 is chemically bonded to support structure 34. For example, at least some of the first polyurethane of tread portion 32 is covalently bonded to at least some of the second polyurethane of support structure 34. This may result in a superior bond than bonds formed via adhesives, mechanisms, or fasteners.

In such embodiments, as a result of the first material characteristics of the first polyurethane being different than the second material characteristics of the second polyurethane, it may be possible to tailor the characteristics of tread portion 32 and support structure 34 to characteristics desired for those respective portions of tire 24. For example, the second polyurethane of support structure 34 may be selected to be relatively stiffer and/or stronger than the first polyurethane of tread portion 32, so that support structure 34 may have sufficient stiffness and strength to support the anticipated load on tires 24. According to some embodiments, the first polyurethane of tread portion 32 may be selected to be relatively more cut-resistant and wear-resistant and/or have a higher coefficient of friction than the second polyurethane, so that regardless of the second polyurethane selected for support structure 34, tread portion 32 may provide the desired wear and/or traction characteristics for tire 24.

For example, the first polyurethane of tread portion 32 may include polyurethane urea materials based on one or more of polyester, polycaprolactone, and polycarbonate polyols that may provide relatively enhanced abrasion resistance. Such polyurethane urea materials may include polyurethane prepolymer capped with methylene diisocyanate (MDI) that may relatively strongly phase segregate and form materials with relatively enhanced crack propagation resistance. Alternative polyurethanes capped with toluene diisocyanate (TDI), napthalene diisocyanate (NDI), and/or para-phenylene diisocyanate (PPDI) may also be used. Such polyurethane prepolymer materials may be cured with aromatic diamines that may also encourage strong phase segregation. Exemplary aromatic diamines include methylene diphenyl diamine (MDA) that may be bound in a salt complex such as tris (4,4′-diamino-diphenyl methane) sodium chloride (TDDM).

According to some embodiments, the first polyurethane may have a Shore hardness ranging from about from 60A to about 60D (e.g., 85 Shore A). For certain applications, such as those with soft ground conditions, it may be beneficial to form tread portion 32 from a material having a relatively harder durometer to generate sufficient traction through tread penetration. For applications such as those with hard or rocky ground conditions, it may be beneficial to form tread portion 32 from a material having a relatively lower durometer to allow conformability of tread portion 32 around hard rocks.

According to some embodiments, the second polyurethane of support structure 34 may include polyurethane urea materials based on one or more of polyether, polycaprolactone, and polycarbonate polyols that may provide relatively enhanced fatigue strength and/or a relatively low heat build-up (e.g., a low tan 8). For example, for high humidity environments it may be beneficial for the second polyurethane to provide a low tan 8 for desired functioning of the tire after moisture absorption. Such polyurethane urea materials may include polyurethane prepolymer capped with methylene diisocyanate (MDI) that may strongly phase segregate and form materials having relatively enhanced crack propagation resistance, which may improve fatigue strength. Alternative polyurethanes capped with toluene diisocyanate (TDI), napthalene diisocyanate (NDI), or para-phenylene diisocyanate (PPDI) may also be used. Such polyurethane prepolymer materials may be cured with aromatic diamines that may also encourage strong phase segregation. Exemplary aromatic diamines include methylene diphenyl diamine (MDA) that may be bound in a salt complex such as tris (4,4′-diamino-diphenyl methane) sodium chloride (TDDM). Chemical crosslinking in the polyurethane urea may provide improved resilience to support structure 34. Such chemical crosslinking may be achieved by any means known in the art, including but not limited to: the use of tri-functional or higher functionality prepolymers, chain extenders, or curatives; mixing with low curative stoichiometry to encourage biuret, allophanate, or isocyanate formation; including prepolymer with secondary functionality that may be cross-linked by other chemistries (e.g., by incorporating polybutadiene diol in the prepolymer and subsequently curing such with sulfur or peroxide crosslinking). According to some embodiments, the second polyurethane of support structure 34 (e.g., a polyurethane urea) may have a Shore hardness ranging from about 80A to about 95A (e.g., 92A).

Some embodiments of tire 24 may include an intermediate portion (not shown) between outer circumferential portion 28 and inner surface 30 of tread portion 32. For example, outer circumferential portion 28 of support structure 34 may be chemically bonded to inner surface 30 of tread portion 32 via an intermediate portion.

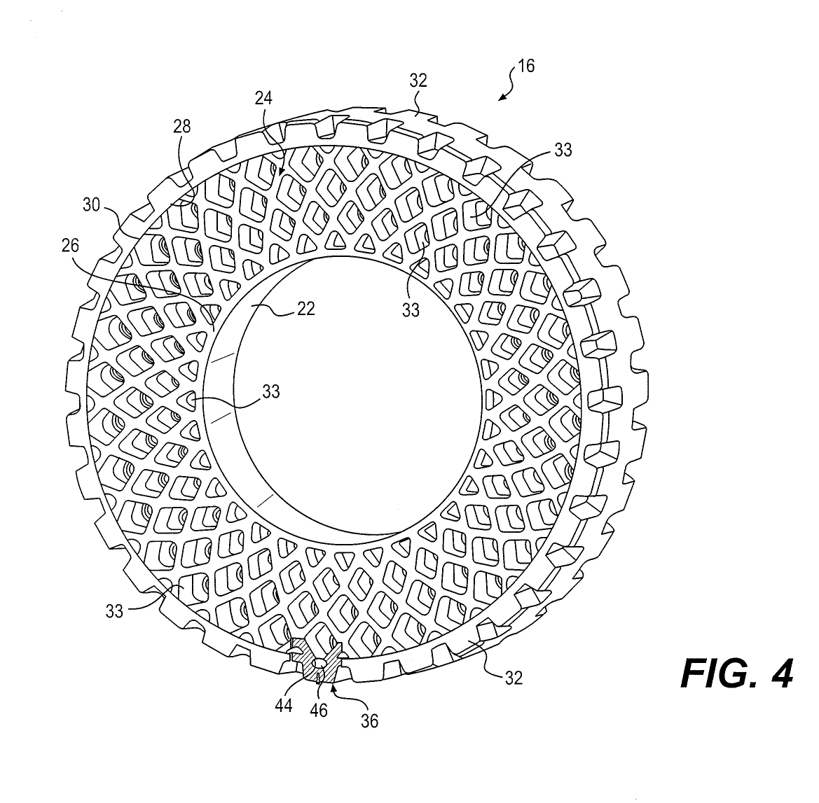

As shown in FIG. 4, some embodiments of tire 24 may include a system 36 for acquiring data associated with tire 24. For example, system 36 may be configured to acquire data associated with wear and/or operation of tire 24. According to some embodiments, system 36 may be configured to monitor the wear of tread portion 32 of tire 24, so that either the entire tire 24 or tread portion 32 may be replaced when tread portion 32 is worn to an undesirable amount. In addition, system 36 may be configured to monitor characteristics such as temperature and/or load of portions of tire 24 (e.g., of support structure 34) in order to reduce the likelihood of exceeding the capabilities of the design and/or material of tire 24. According to some embodiments, such monitoring may occur real-time and/or may be recorded for later download and analysis.

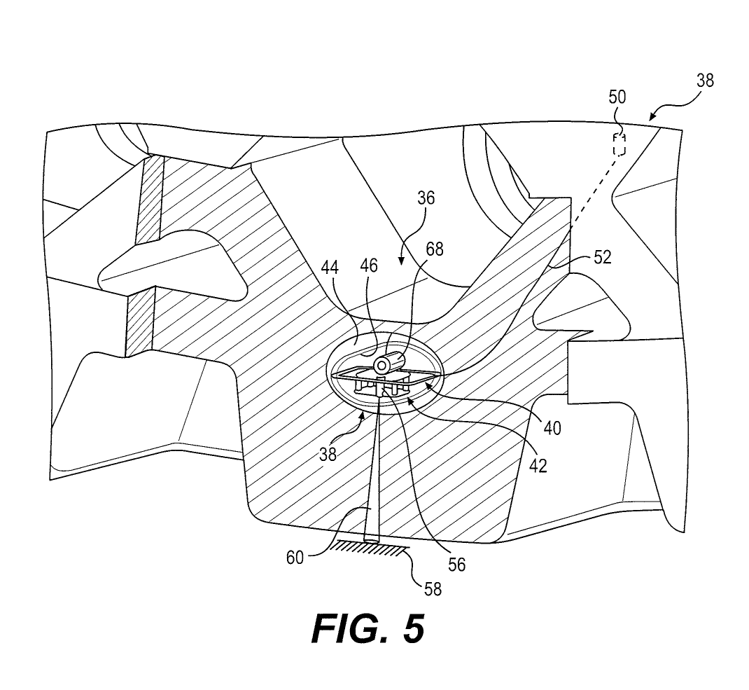

As shown in FIGS. 4 and 5, exemplary system 36 for tire 24 includes at least one sensor 38 associated with at least a portion of tire 24, such as tread portion 32 and/or support structure 34. Sensor 38 is configured to generate signals indicative of at least one characteristic related to the associated portion of tire 24. Exemplary system 36 also includes at least one receiver 40 associated with at least one portion of a portion of tire 24, such as tread portion 32 and/or support structure 34. Receiver 40 is configured to receive signals from the at least one sensor 38. Exemplary system 36 also includes a transmitter 42 associated with a portion of tire 24, such as tread portion 32 and/or support structure 34. Transmitter 42 is configured to transmit signals indicative of the at least one characteristic to a location remote from the tire 24.

For example, in the exemplary embodiment shown in FIGS. 4 and 5, tire 24 includes a pocket 44 configured to receive at least one of sensor 38, receiver 40, and transmitter 42. For example, exemplary pocket 44 is located in tread portion 32. According to some embodiments, pocket 44 may be located in support structure 34, or partially located in both tread portion 32 and support structure 34.

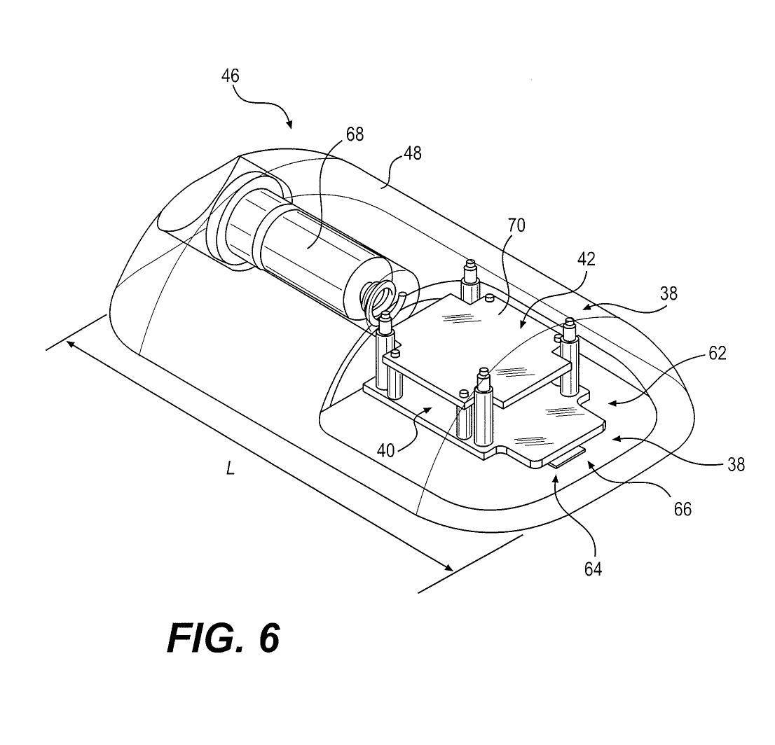

According to some embodiments, at least one of sensor 38, receiver 40, and transmitter 42 may physically coupled to one another to form a module 46, for example, as shown in FIG. 6. For example, module 46 may be embedded in a casing 48 that may, in turn, be received in pocket 44. For example, tread portion 32 and/or support structure 34 may be formed of polyurethane or similar material, and casing 48 may be formed of polyurethane or similar material. According to some embodiments, casing 48, tread portion 32, and/or support structure 34 may be formed of the same material. According to some embodiments, one or more of casing 48, tread portion 32, and support structure 34 may be formed of materials having material characteristics that are different from one another. According to some embodiments, system 36 may include a plurality of modules 46 located throughout tire 24.

According to some embodiments, sensor 38 may include one or more sensors 50 (FIG. 5) configured to generate signals indicative of the temperature of a portion of tire 24. For example, one or more of sensors 50 may include a thermocouple coupled to module 46, for example, via a wired link 54, as shown in FIG. 5. The use of other types or forms of sensor(s) 50 are contemplated.

According to some embodiments, system 36 may include a plurality of sensors 50 positioned (e.g., embedded in tread portion 32 and/or support structure 34) to facilitate monitoring of the temperature of the associated portion of tire 24. Such temperature information may be useful in analyzing stress in the associated portion of tire 24 and/or reducing the likelihood of operating tire 24 in a manner resulting in the material of tire 24 exceeding desired temperatures, which may lead to excessive wear, cracking, or premature degradation, for example, if the material is polyurethane or a similar material.

According to some embodiments, one or more of sensors 38 may include sensors 56 (FIG. 5) configured to generate signals indicative the level of tread wear of tread portion 32. For example, sensor 56 may include an ultrasonic sensor configured to generate signals indicative of the depth of tread portion 32, for example, by ultrasonically determining the distance from sensor 56 to the terrain 58 on which tire 24 is rolling by virtue of the reflection of an ultrasonic signal 60 from terrain 58. The use of sensors other than ultrasonic sensors is contemplated.

According to some embodiments, one or more of sensors 38 may include sensors 62 configured to generate signals indicative of the motion of tire 24. For example, sensors 62 may be configured to generate signals indicative of position, speed, velocity, and/or acceleration associated with tire 24 and/or a portion of tire 24. Such sensors 62 may include, for example, accelerometers or similar sensors. Such data may be useful for understanding the stresses and loads to which tire 24 is subjected during machine operation, and this may be useful for improving tire 24.

According to some embodiments, one or more of sensors 38 may include sensors 64 configured to generate signals indicative of loads on tire 24. For example, sensors 64 may include load cells, strain gauges, or similar sensors. Such load information may be useful in analyzing stress in the associated portion of tire 24 and/or reducing the likelihood of operating tire 24 in a manner resulting in the material of tire 24 being subjected to loads higher than desired, which may lead to excessive wear, cracking, or premature degradation. According to some embodiments, one or more sensors 36 may include sensors 66 configured generate signals indicative of the moisture content of the material of tire 24 associated with sensors 66. Such sensors 66 may be useful for tires 24 formed from a material for which moisture content may be an important consideration for reliable operation of tire 24.

As shown in FIGS. 5 and 6, exemplary system 36 includes a power supply 68 configured to supply power to system 36 to provide power to one or more of sensors 36, receiver 40, and transmitter 42. For example, power supply 68 may include one or more batteries and/or a power conversion device. For example, power conversion devices may be configured to generate power from motion, load, and/or temperature associated with tire 24. For example, such conversion devices may include power harvesting devices such as piezoelectric power generators configured to convert motion such as vibrations into electric power.

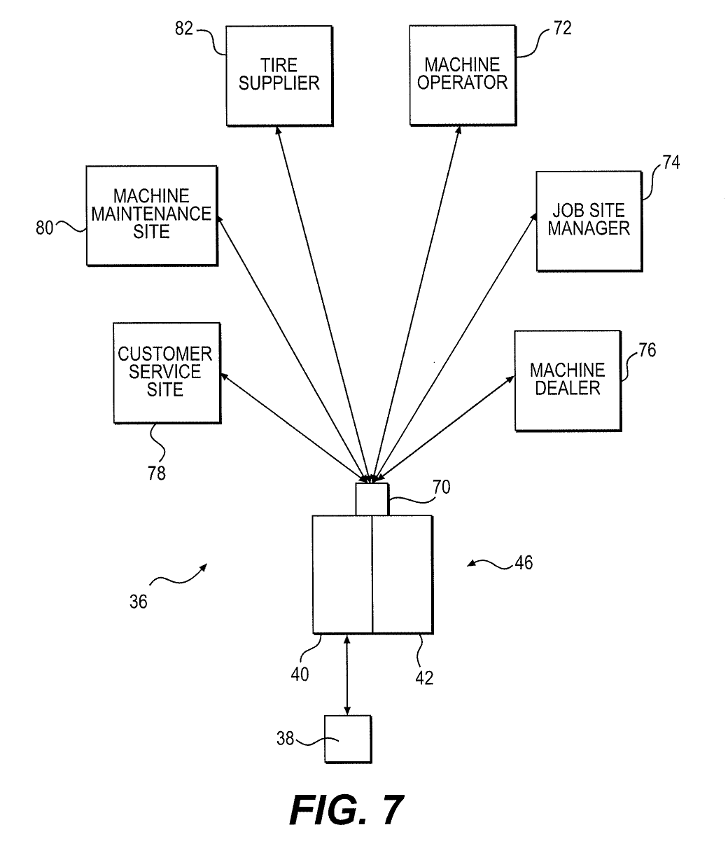

As shown in FIG. 6, some embodiments of system 36 may include an antenna 70, which may be coupled to receiver 40 and/or transmitter 42 and may be configured to wirelessly receive and/or transmit data. For example, receiver 40 may be configured to wirelessly receive data or instructions from a source or location remote from tire 24. According to some embodiments, transmitter 42 may be configured to wirelessly transmit data or instructions from tire 24 to a location remote from tire 24. For example, as shown in FIG. 7, transmitter 42 may be configured to transmit data associated with system 36 to, for example, an operator 72 of machine 10, a jobsite manager 74 located in, for example, a local worksite facility, a machine dealer 76, a customer service site 78, a machine maintenance site 80, and/or a tire supplier 82. According to some embodiments, receiver 40 may be configured to receive data and/or programming from, for example, machine operator 72, jobsite manager 74, machine dealer 76, customer service site 78, machine maintenance site 80, and/or tire supplier 82. According to some embodiments, receiver 40 and/or transmitter 42 may be configured to receive and transmit data via a physical link such as a wired link via a plug-in connector (not shown).

According to some embodiment, system 36, including sensor 38, receiver 40, transmitter 42, and/or antenna 70 may be formed into an integrated single piece embedded in casing 48. For example, casing 48 may be formed from, for example, a polyurethane that is curable at room temperature (e.g., between about 15° C. to about 30° C.). Thereafter, casing 48 can be inserted into pocket 44. Alternatively, sensor 38, receiver 40, transmitter 42, and/or antenna 70 may be inserted into pocket 44 and casing material may be supplied to pocket 44 to embed sensor 38, receiver 40, transmitter 42, and/or antenna 70 into casing 48 and pocket 44. This may result in module 46 being securely embedded in tire 24 in a manner that avoids subjecting sensor 38, receiver 40, transmitter 42, and/or antenna 70 to relatively higher temperatures that may be associated with curing the material of tire 24 (e.g., about 135° C. for some polyurethanes). Such relatively high temperatures might damage sensor 38, receiver 40, transmitter 42, and/or antenna 70.

According to some embodiments, sensors 38, receiver 40, transmitter 42, and/or antenna 70 may include any components that may be used to run an application associated with system 36, such as, for example, memory, secondary storage, a processing unit, power supply circuitry, signal-conditioning circuitry, and/or other appropriate circuitry.

According to some embodiments, system 36 may be configured to acquire and send data associated with tire 24 at a dynamic transmission rate. For example, transmitter 42 may be configured to send data associated with the wear of tread portion 32 based on the level of tread wear acquired from, for example, signals received from sensor 56 configured generate signals indicative the level of wear of wear of tread portion 32. For example, when tire 24 (and/or tread portion 32 of tire 24) is relatively new or unworn, system 36 may be configured to send tread wear data once per day. As the level of tread wear approaches 25%, system 36 may be configured to send tread wear data twice per day, and as the level of tread wear approaches 90%, system 36 may be configured to send tread wear data every hour. This exemplary dynamic data transmission rate may conserve power supply 68, particularly if power supply 68 includes a battery.

According to some embodiments, system 36 may include a dormant trigger breakaway circuit configured to initiate acquisition of data related to the level of tread wear upon reaching a predetermined tread wear depth. For example, a sensor may be molded into tread portion 32 at a predetermined tread depth, and once tread portion 32 wears to the predetermined tread depth, the sensor is configured to trigger acquisition and/or transmission of tread wear data, for example, as previously described.

According to some embodiments, at a predetermined level of tread wear (e.g., 90%), system 36 may be configured to send tread wear data to one or more of machine operator 72, jobsite manager 74, machine dealer 76, customer service site 78, machine maintenance site 80, and/or tire supplier 82. According to some embodiments, at a predetermined level of tread wear (e.g., 90%), system 36 may be configured to initiate placement of an order for a new tire, for example, either via direct communication with tire supplier 82 or indirectly via one or more of machine operator 72, jobsite manager 74, machine dealer 76, customer service site 78, and machine maintenance site 80.

According to some embodiments, acquisition of tread wear data may be initiated and/or controlled from a location remote from tire 24, such as, for example, from machine operator 72, jobsite manager 74, machine dealer 76, customer service site 78, machine maintenance site 80, and/or tire supplier 82. For example, one or more of these remote locations may transmit control signals to system 36, and system 36 may be configured to initiate data acquisition, select the type of data to be acquired, and/or select the transmission rate of such data based on the control signals.

According to some embodiments, transmitter 42 may be configured to send data associated with the temperature of one or more portions of support structure 34 based on temperature data acquired from, for example, signals received from one or more sensors 50 configured to generate signals indicative of temperature of a portion of tire 24. During operation of machine 10, the temperature of the material of tire 24 may be heated at portions of tire 24 subjected to stress due to loading of tire 24 and/or design configuration (e.g., in the areas of cavities 33), and it may be desirable to operate machine 10 such that the temperature of such portions of tire 24 do not exceed a desired maximum temperature, for example, in order to prevent damage to tire 24.

According to some embodiments, system 36 may be configured to acquire and send temperature data associated with tire 24 at a dynamic transmission rate. For example, transmitter 42 may be configured to send temperature data based on signals indicative of the temperature of tread portion 32 or support structure 34 acquired from, for example, sensors 50. For example, as the temperature of portions of tire 24 increase, the rate of transmission of temperature data may increase. For example, if the temperature of portions of tire 24 remains below, for example, 80° C., system 36 may acquire and transmit temperature data every five minutes. However, if the temperature of any portions of tire 24 exceeds 80° C., system 36 may acquire and transmit temperature data every minute. If the temperature of any portions of tire 24 reaches, for example, 100° C., system 36 may acquire and transmit temperature data continuously and/or may send an alarm single to one or more of machine operator 72, jobsite manager 74, machine dealer 76, customer service site 78, machine maintenance site 80, and/or tire supplier 82. This may reduce the likelihood of tire 24 being damaged to due excessive heat, which may result in premature breakdown of the material of tire 24 (e.g., polyurethane).

### INDUSTRIAL APPLICABILITY

The tires disclosed herein may be used with any machines, including self-propelled vehicles or vehicles intended to be pushed or pulled by another machine. According to some embodiments, the tires may be molded, non-pneumatic tires formed from polyurethane and similar materials. According to some embodiments, the tires may include a system for acquiring data associated with the tires. This data may include data related to tread wear, internal tire temperatures (e.g., temperatures related to portions of support structure 34), tire speed, and loads and stress to which the tire is subjected during machine operation.

Data associated with tread wear may be used to monitor tread wear and to provide updates or warnings to machine operator 72, jobsite manager 74, machine dealer 76, customer service site 78, and/or machine maintenance site 80. According to some embodiments, the rate of data acquisition and/or transmission may change as the level of wear of tire 24 increases. This may serve to reduce demands on power supply 68 until tread wear reaches a point at which it may be desirable to more closely monitor tread wear. According to some embodiments, system 36 may be configured to send signals to initiate an order for a new or remanufactured (e.g., re-treaded) tire 24, so that a new tire 24 is available for being exchanged with a tire 24 beyond a desired amount.

Tire 24 may also be configured to monitor internal temperatures of different portions of tire 24, such as, for example, tread portion 32 and/or support structure 34. Such temperature monitoring may serve to prevent the material of portions of tire 24 from approaching or reaching undesirably high temperatures that might lead to premature break-down of the material forming tire 24. According to some embodiments, the rate of acquisition and transmission of tire temperature information may increase as the temperature of portions of tire 24 reach predetermined thresholds. This may serve to reduce demands on power supply 68 until internal tire temperatures reach a point at which it may be desirable to more closely monitor the temperatures. Tire temperature data may also be useful for understanding the portions of tire 24 that are subjected to higher loads and stress, which may lead to design improvements.

Tire 24 may also include sensors 62 configured to generate signals indicative of motion for monitoring data related to movement, speed, velocity, and/or acceleration of portions of tire 24. This data may useful for understanding loads and stresses to which tire 24 is subjected. This may lead to design improvements. According to some embodiments, tire 24 may include sensors 64 configured to generate signals indicative of load or stress associated with different portions of tire 24 during operation, which may lead to identifying portions of tire 24 that are subjected to the highest loads. This may also prevent overloading of tire 24 or lead to improvements in the tire 24. Some embodiments may include sensors configured to generate signals indicative of the moisture content in portions of tire 24. This may facilitate monitoring of moisture levels in the material forming tire 24, which may be desirable for some materials, such as, for example, polyurethane or similar materials.

According to some embodiments, system 36 of tire 24 may be configured to transmit data via wireless communication. This may permit real-time monitoring of information associated with characteristics of tire 24. According to some embodiments, system 36 of tire 24 may be configured to store information associated with characteristics of tire 24 for being downloaded at a later time, for example, via either a wireless connecting or a hard-wired connection. According to some embodiments, system 36 of tire 24 may be configured to receive control signals from a remote location. Such signals may be useful for changing the rate of transmission of tire data and/or the type of data transmitted.

According to some embodiments, power supply 68 of system 36 may include at least one of batteries and devices for harvesting power configured to convert movement (e.g., vibration) and/or heat into electric power. Such harvesting devices may increase the service life of system 36 relative to systems relying solely on batteries as a power source.

Some embodiments may include a module 46 including casing 48 in which at least one of sensor 38, receiver 40, and transmitter 42 are embedded. For example, casing 48 may be formed from a material similar to the material forming tread portion 32 and/or support structure 34 of tire 24, so that module 46 may be securely integrated into tire 24. According to some embodiments, the material forming casing 48 may be curable at room temperature to prevent damage to sensor 38, receiver 40, and transmitter 42 that may occur if subjected to temperatures sometimes associated with curing polyurethane. This may permit the use of relatively sensitive and/or delicate electronics in module 46.

It will be apparent to those skilled in the art that various modifications and variations can be made to the exemplary disclosed tires, systems, and methods. Other embodiments will be apparent to those skilled in the art from consideration of the specification and practice of the exemplary disclosed embodiments. It is intended that the specification and examples be considered as exemplary only, with a true scope being indicated by the following claims and their equivalents.

What is claimed is:

1. A non-pneumatic tire comprising:
a support structure having an inner circumferential portion and an outer circumferential portion, the inner circumferential portion being configured to be associated with a hub;
a tread portion associated with the outer circumferential portion of the support structure;
at least one sensor associated with at least one of the support structure and the tread portion and configured to generate signals indicative of at least one characteristic associated with at least one of the support structure and the tread portion of the tire;
a receiver associated with at least one of the support structure and the tread portion and configured to receive signals from the at least one sensor; and
a transmitter associated with at least one of the support structure and the tread portion and configured to transmit signals indicative of the at least one characteristic to a location remote from the tire.

2. The tire of claim 1, wherein at least one of the support structure and the tread portion includes a pocket, and at least one of the sensor, the receiver, and the transmitter is received in the pocket.

3. The tire of claim 2, wherein at least one of the sensor, the receiver, and the transmitter is embedded in a casing, and the casing is received in the pocket.

4. The tire of claim 1, wherein the at least one sensor includes at least one of:
a temperature sensor configured to generate signals indicative of a temperature associated with a portion of the tire;
a sensor configured to generate signals indicative of a level of tread wear of the tread portion;
a sensor configured to generate signals indicative of motion of the tire;
a sensor configured to generate signals indicative of loads on the tire; and
a sensor configured to generate signals indicative of moisture content in material forming the tire.

5. The tire of claim 4, wherein the at least one sensor includes a sensor configured to generate signals indicative of the level of tread wear of the tread portion, and the sensor includes an ultrasonic sensor configured to measure tread depth.

6. The tire of claim 1, further including a power supply configured to supply power to at least one of the sensor, the receiver, and the transmitter, and wherein the power supply includes at least one of batteries and a conversion device configured to convert motion or heat associated with the tire into power.

7. The tire of claim 1, wherein the receiver is configured to receive signals from a location remote from the tire.

8. The tire of claim 1, wherein at least one of the receiver and the transmitter is configured to receive and send signals wirelessly.

9. The tire of claim 4, wherein the at least one sensor includes a sensor configured to generate signals indicative of the level of tread wear of the tread portion, and wherein the transmitter is configured to send data associated with tread wear at a transmission rate based on the level of tread wear.

10. The tire of claim 4, wherein the at least one sensor includes a sensor configured to generate signals indicative of a temperature associated with a portion of the tire, and wherein the transmitter is configured to send data associated with the temperature at a transmission rate based on the temperature.

11. The tire of claim 1, wherein the tire is a molded tire including polyurethane.

12. A system for acquiring data associated with a non-pneumatic tire, the system comprising:
at least one sensor configured to be received in a portion of the tire and to generate signals indicative of at least one characteristic associated with the tire;
a receiver configured to be received in a portion of the tire and to receive signals from the at least one sensor; and
a transmitter configured to be received in a portion of the tire and to transmit signals indicative of the at least one characteristic to a location remote from the tire.

13. The system of claim 12, wherein the tire includes:
a support structure having an inner circumferential portion and an outer circumferential portion, the inner circumferential portion being configured to be associated with a hub; and
a tread portion associated with the outer circumferential portion of the support structure,
wherein the at least one sensor is configured to be associated with at least one of the support structure and the tread portion, and to generate signals indicative of at least one characteristic associated with at least one of the support structure and the tread portion of the tire,
wherein the receiver is configured to be associated with at least one of the support structure and the tread portion, and
wherein the transmitter is configured to be associated with at least one of the support structure and the tread portion.

14. The system of claim 12, wherein the receiver is a first receiver, and the system further includes a second receiver configured to be remote from the tire and receive signals indicative of the at least one characteristic from the transmitter.

15. The system of claim 12, wherein at least one of the sensor, the receiver, and the transmitter is embedded in a casing, and the casing is configured to be received in a pocket of the tire.

16. The system of claim 12, wherein the at least one sensor includes at least one of:
a temperature sensor configured to generate signals indicative of a temperature associated with a portion of the tire;
a sensor configured to generate signals indicative of a level of tread wear of a tread portion of the tire;
a sensor configured to generate signals indicative of motion of the tire;
a sensor configured to generate signals indicative of loads on the tire; and
a sensor configured to generate signals indicative of moisture content in material forming the tire.

17. The system of claim 16, wherein the at least one sensor includes a sensor configured to generate signals indicative of the level of tread wear of the tread portion, and the sensor includes an ultrasonic sensor configured to measure tread depth.

18. The system of claim 12, further including a power supply configured to supply power to at least one of the sensor, the receiver, and the transmitter, and wherein the power supply includes at least one of batteries and a conversion device configured to convert motion or heat associated with the tire into power.

19. The system of claim 12, wherein the receiver is configured to receive signals from a location remote from the tire.

20. The system of claim 12, wherein at least one of the receiver and the transmitter is configured to receive and send signals wirelessly.

21. A method for acquiring data associated with a non-pneumatic tire, the method comprising:
generating signals via at least one sensor received in a portion of the tire, the signals being indicative of at least one characteristic associated with the tire;
receiving via a receiver received in a portion of the tire, the signals associated with the at least one characteristic; and
transmitting via a transmitter received in a portion of the tire, the signals associated with the at least one characteristic to a location remote from the tire.

22. The method of claim 21, wherein generating signals includes generating signals indicative of at least one of:
a temperature associated with a portion of the tire;
a level of tread wear of a tread portion of the tire;
motion of the tire;
loads on the tire; and
moisture content in material forming the tire.

23. The method of claim 22, wherein generating signals includes generating signals indicative of a level of tread wear of the tread portion; and generating signals indicative of the level of tread wear includes generating ultrasonic signals configured to measure tread depth.

24. The method of claim 21, further including supplying power to at least one of the sensor, the receiver, and the transmitter via at least one of batteries and a conversion device configured to convert motion or heat associated with the tire into power.

25. The method of claim 21, wherein at least one of receiving and transmitting signals includes respectively receiving signals and transmitting signals wirelessly.

26. The method of claim 22, wherein transmitting signals includes transmitting signals indicative of tread wear at a transmission rate based on a level of tread wear.

27. The method of claim 22, wherein transmitting signals includes transmitting signals indicative of temperature at a transmission rate based on a temperature associated with a portion of the tire.
